(19) United States
(12) Patent Application Publication
(10) Pub. No.: US 2013/0327211 A1
(43) Pub. Date: Dec. 12, 2013

(54) LOCKING PNEUMATIC PISTON

(71) Applicants: Phillip Booth, Bristol (GB); Mark Sealy, Warwickshire (GB); Stuart Davey, Columbus, IN (US)

(72) Inventors: Phillip Booth, Bristol (GB); Mark Sealy, Warwickshire (GB); Stuart Davey, Columbus, IN (US)

(73) Assignee: NORGREN LIMITED, STAFFORDSHIRE (GB)

(21) Appl. No.: 13/979,801

(22) PCT Filed: Jan. 30, 2012
(86) PCT No.: PCT/GB12/50181

§ 371 Date: Jul. 15, 2013

(30) Foreign Application Priority Data
Feb. 2, 2011 (GB) 1101787.8

(51) Int. Cl. F16J 1/00

(52) U.S. Cl. CPC F16J 1/00
USPC 92/172; 29/888.04

(57) ABSTRACT

A locking pneumatic piston (100) is provided. The locking pneumatic piston (100) includes a piston rod (113) connected to a piston (120) located in a piston chamber (103) and extending out of the piston chamber (103). The locking pneumatic piston (100) further includes a locking seal (124) extending around and positioned at a circumferential surface (126) of the piston (120) and an internal pneumatic channel (127) extending through at least a lengthwise portion of the piston rod (113) and through the piston (120) to the locking seal (124). When a pneumatic locking pressure is provided to the internal pneumatic channel (127), the pneumatic locking pressure extends the locking seal (124) at least partially outward and away from the piston (120) and presses against the inner surface (104) of the piston chamber (103), substantially locking the piston (120) in place within the piston chamber (103).

### BACKGROUND OF THE INVENTION

1. FIELD OF THE INVENTION

The invention is related to the field of pneumatic pistons, and more particularly, to a locking pneumatic piston.

2. DESCRIPTION OF THE PRIOR ART

Pneumatic actuators and/or pneumatic pistons are mechanical devices that can convert pneumatic pressure to mechanical energy or vice versa. Pneumatic pressure can be provided to a pneumatic actuator/piston in order to move a piston rod and any associated mechanical work piece. Alternatively, a piston rod and piston can be moved in order to increase or decrease an associated pneumatic pressure.

Pneumatic actuators/pistons can be used in a variety of applications, such as in industrial machines and in industrial processes. Increasingly, pneumatic actuators/pistons are used in vehicles. A relatively new application is as a tensioner device for seatbelts, tensioning a seatbelt when a collision has been detected and before occupants of the vehicle are affected. The pneumatic actuator/piston can be actuated in order to take up slack in and/or tension the seatbelt in some manner. Other new applications include airbag deployment and hood lift systems, among others.

For some applications, such as a seatbelt tensioner application, for example, it may be desirable to lock the piston at a certain point in the actuation, such as when tensioning has been substantially achieved. In other applications, it may be desirable to lock the pneumatic actuator/piston in one or more various positions.

This may be advantageous in terms of the required volume and the required pressure of the supplied pneumatic air. This may be advantageous in terms of preventing subsequent movement/relaxation of the actuator/piston, as a change in load on the actuator/piston may cause the actuator/piston to move. This may be advantageous when the actuator/piston may be subject to large impulse loads, such as during a collision.

It is desirable that the lock mechanism be achieved with few parts. It is desirable that the lock mechanism is simple and robust. It is desirable that the lock mechanism be pneumatically actuated.

### ASPECTS OF THE INVENTION

In one aspect of the invention, a locking pneumatic piston comprises:
a piston rod connected to a piston located in a piston chamber, with the piston rod extending out of the piston chamber;
a locking seal extending around and positioned at a circumferential surface of the piston and substantially sealing the piston to an inner surface of the piston chamber; and
an internal pneumatic channel extending through at least a lengthwise portion of the piston rod and through the piston to the locking seal;
wherein when a pneumatic locking pressure is provided to the internal pneumatic channel, the pneumatic locking pressure extends the locking seal at least partially outward and away from the piston and presses against the inner surface of the piston chamber, substantially locking the piston in place within the piston chamber.

Preferably, the inner surface of the piston chamber is substantially smooth.

Preferably, the inner surface of the piston chamber further comprises one or more detent features.

Preferably, the locking seal provides a first sealing force against the inner surface in an absence of pneumatic locking pressure and provides a second sealing force when pneumatic locking pressure is provided at the internal pneumatic channel, with the second sealing force being greater than the first sealing force.

Preferably, the locking seal is at least partially elastomeric.

Preferably, the locking pneumatic piston further comprises:
a seal groove formed in the circumferential surface of the piston, with the seal groove being configured to receive at least a portion of the locking seal; and
one or more passages extending between the internal pneumatic channel and the seal groove.

Preferably, the locking pneumatic piston further comprises a pneumatic lock port formed on the piston rod outside of the piston chamber, with the pneumatic lock port being in communication with the internal pneumatic channel.

In one aspect of the invention, a method of providing a locking pneumatic piston comprises:
providing a pneumatic piston including a piston rod; and
providing a pneumatic lock port formed in an exterior portion of the piston rod outside of a piston chamber, wherein a pneumatic lock pressure provided to the pneumatic lock port substantially locks the piston rod in position with respect to the pneumatic piston.

Preferably, providing the pneumatic piston further comprises:
providing the piston rod connected to a piston located in the piston chamber, with the piston rod extending out of the piston chamber;
providing a locking seal extending around and positioned at a circumferential surface of the piston and substantially sealing the piston to an inner surface of the piston chamber; and
providing an internal pneumatic channel extending through at least a lengthwise portion of the piston rod and through the piston to the locking seal;
wherein when a pneumatic locking pressure is provided to the internal pneumatic channel, the pneumatic locking pressure extends the locking seal at least partially outward and away from the piston and presses against the inner surface of the piston chamber, substantially locking the piston in place within the piston chamber.

Preferably, the inner surface of the piston chamber is substantially smooth.

Preferably, the inner surface of the piston chamber further comprises one or more detent features.

Preferably, the locking seal provides a first sealing force against the inner surface in an absence of pneumatic locking pressure and provides a second sealing force when pneumatic locking pressure is provided at the internal pneumatic channel, with the second sealing force being greater than the first sealing force.

Preferably, the locking seal is at least partially elastomeric.

Preferably, the method further comprises:
providing a seal groove formed in the circumferential surface of the piston, with the seal groove being configured to receive at least a portion of the locking seal; and
providing one or more passages extending between the internal pneumatic channel and the seal groove.

Preferably, the pneumatic lock port is in communication with the internal pneumatic channel.

In one aspect of the invention, a method of providing a locking pneumatic piston comprises:
providing a pneumatic piston including a piston rod;
providing an internal lock mechanism; and
providing a pneumatic lock port formed in an exterior portion of the piston rod outside of a piston chamber and communicating a pneumatic lock pressure in communication with the lock mechanism, wherein the pneumatic lock pressure substantially locks the piston rod in position with respect to the pneumatic piston.

Preferably, providing the pneumatic piston and providing the internal lock mechanism further comprises:
providing the piston rod connected to a piston located in the piston chamber, with the piston rod extending out of the piston chamber;
providing a locking seal extending around and positioned at a circumferential surface of the piston and substantially sealing the piston to an inner surface of the piston chamber; and
providing an internal pneumatic channel extending through at least a lengthwise portion of the piston rod and through the piston to the locking seal;
wherein when a pneumatic locking pressure is provided to the internal pneumatic channel, the pneumatic locking pressure extends the locking seal at least partially outward and away from the piston and presses against the inner surface of the piston chamber, substantially locking the piston in place within the piston chamber.

Preferably, the inner surface of the piston chamber is substantially smooth.

Preferably, the inner surface of the piston chamber further comprises one or more detent features.

Preferably, the locking seal provides a first sealing force against the inner surface in an absence of pneumatic locking pressure and provides a second sealing force when pneumatic locking pressure is provided at the internal pneumatic channel, with the second sealing force being greater than the first sealing force.

Preferably, the locking seal is at least partially elastomeric.

Preferably, the method further comprises:
providing a seal groove formed in the circumferential surface of the piston, with the seal groove being configured to receive at least a portion of the locking seal; and
providing one or more passages extending between the internal pneumatic channel and the seal groove.

Preferably, the pneumatic lock port is in communication with the internal pneumatic channel.

In one aspect of the invention, a locking pneumatic piston comprises:
a carriage connected to a piston located in a piston chamber, with the carriage positioned out of the piston chamber;
one or more locking seals extending around and positioned at a circumferential surface of the piston and substantially sealing the piston to an inner surface of the piston chamber; and
an internal pneumatic channel extending through at least a portion of the carriage and through the piston to the one or more locking seals;
wherein when a pneumatic locking pressure is provided to the internal pneumatic channel, the pneumatic locking pressure extends the one or more locking seals at least partially outward and away from the piston and presses against the inner surface of the piston chamber, substantially locking the piston in place within the piston chamber.

Preferably, the inner surface of the piston chamber is substantially smooth.

Preferably, the inner surface of the piston chamber further comprises one or more detent features.

Preferably, the locking seal provides a first sealing force against the inner surface in an absence of pneumatic locking pressure and provides a second sealing force when pneumatic locking pressure is provided at the internal pneumatic channel, with the second sealing force being greater than the first sealing force.

Preferably, the locking seal is at least partially elastomeric.

Preferably, the locking pneumatic piston further comprises:
one or more seal grooves formed in the circumferential surface of the piston, with each of the seal grooves being configured to receive at least a portion of a locking seal of the one or more locking seals; and
one or more passages extending between the internal pneumatic channel and the one or more seal grooves.

Preferably, the locking pneumatic piston further comprises a pneumatic lock port formed on the carriage, with the pneumatic lock port being in communication with the internal pneumatic channel.

### BRIEF DESCRIPTION OF THE DRAWINGS

The same reference number represents the same element on all drawings. It should be understood that the drawings are not necessarily to scale.

FIG. 1 shows a locking pneumatic piston according to an embodiment of the invention.

FIG. 2 shows a locking seal of the locking pneumatic piston in a substantially non-actuated position according to an embodiment of the invention.

FIG. 3 shows the locking seal in a substantially actuated position according to an embodiment of the invention.

FIG. 4 shows the locking seal in a substantially extended state and engaging one or more detent features formed in an inner surface of a piston chamber/piston case.

FIG. 5 shows an alternate shape of the locking seal according to an embodiment of the invention.

FIG. 6 shows an alternate shape of the locking seal according to an embodiment of the invention.

FIG. 7 shows an alternate shape of the locking seal according to an embodiment of the invention.

FIG. 8 shows a locking pneumatic piston according to another embodiment.

### DETAILED DESCRIPTION OF THE INVENTION

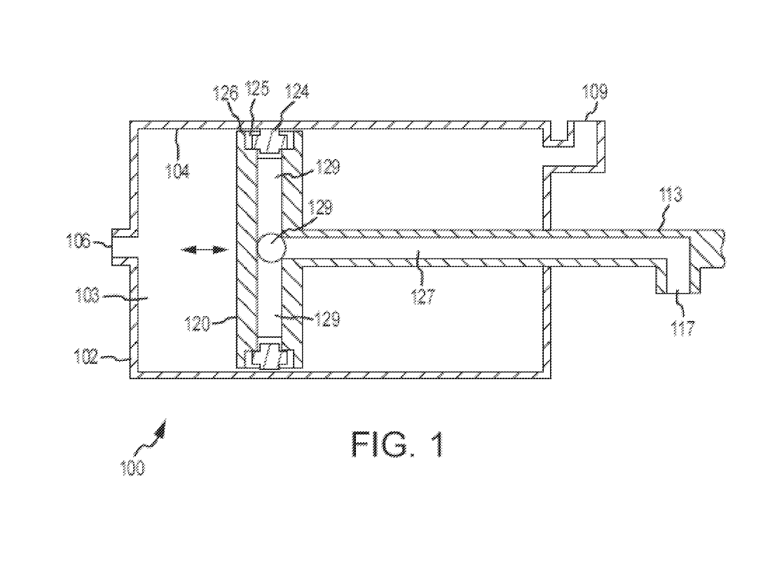

FIGS. 1-8 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a locking pneumatic piston 100 according to an embodiment of the invention. The locking pneumatic piston 100 comprises a piston case 102 including a first port 106 and a second port 109. Pneumatic (i.e., pressurized) air can be introduced into and exhausted from the locking pneumatic piston 100 via the first and second ports 106 and 109. The piston case 102 includes a piston chamber 103 including an inner surface 104. A piston 120 is located within the piston chamber 103 and includes a piston rod 113 that extends out of the piston chamber 103. The piston rod 113 can be rigidly or pivotally attached to the piston 120.

The piston 120 includes a circumferential surface 126 that contacts or comes into close proximity with the inner surface 104 of the piston chamber 103. The piston 120 further includes a seal groove 125 that receives a locking seal 124.

An internal pneumatic channel 127 extends at least a lengthwise portion of the piston rod 113. One or more passages 129 extend from the internal pneumatic channel 127 to the seal groove 125 and communicate with the seal groove 125. The one or more passages 129 provide a pneumatic locking pressure to the seal groove 125, under the locking seal 124. Four passages 129 are included in the embodiment shown in the figure.

The internal pneumatic channel 127 further communicates with a pneumatic lock port 117 that is located outside the piston chamber 103. The pneumatic lock port 117 is formed on the piston rod 113 in some manner. The pneumatic locking pressure provided to the pneumatic lock port 117 is communicated to the internal pneumatic channel 127, to the one or more passages 129, and to the seal groove 125 and the locking seal 124. The pneumatic locking pressure can extend the locking seal 124 at least partially outward and away from the piston 120 and can press the locking seal 124 substantially against the inner surface 104 of the piston chamber 103. The locking seal 124 therefore substantially locks the piston 120 in place within the piston chamber 103. The locking seal 124 therefore comprises an internal lock mechanism, in combination with the seal groove 125, the one or more passages 129, and the internal pneumatic channel 127.

The locking can prevent slippage or movement of the locking pneumatic piston 100. The locking can prevent movement due to leakage of pneumatic pressure within the locking pneumatic piston 100. The locking can prevent movement due to expansion or contraction of air within the locking pneumatic piston 100. The locking can remove the necessity for maintaining the pneumatic pressure within the locking pneumatic piston 100.

The locking pneumatic piston 100 can be pneumatically locked in position. The locking pneumatic piston 100 can be locked at substantially any position in some embodiments. The locking pneumatic piston 100 can be reversibly locked and unlocked. The locking pneumatic piston 100 can be locked or unlocked at any time. The locking pneumatic piston 100 can be locked for any amount of time. The locking pneumatic piston 100 can be quickly locked or unlocked.

In operation, the locking pneumatic piston 100 can be actuated and the piston 120 can be moved reciprocally in the piston chamber 103 so that the piston rod 113 moves into and out of the piston case 102. In addition, the locking capability can be deployed when the piston 120 is at any position within the piston chamber 103 and can be deployed when the piston 120 is locked or stationary. The locking capability can be deployed by providing a pneumatic locking pressure into the pneumatic lock port 117, wherein the pneumatic locking pressure at least partially extends the locking seal 124 from the circumferential surface 126 of the piston 120. The locking seal 124 can contact and exert a pressure on the inner surface 104 of the piston chamber 103.

In some embodiments, the locking pneumatic piston 100 converts pneumatic pressure provided in the piston chamber 103 into mechanical force and/or movement at the piston rod 113. In other embodiments, the locking pneumatic piston 100 converts mechanical force and/or movement provided at the piston rod 113 into pneumatic pressure in the piston chamber 103.

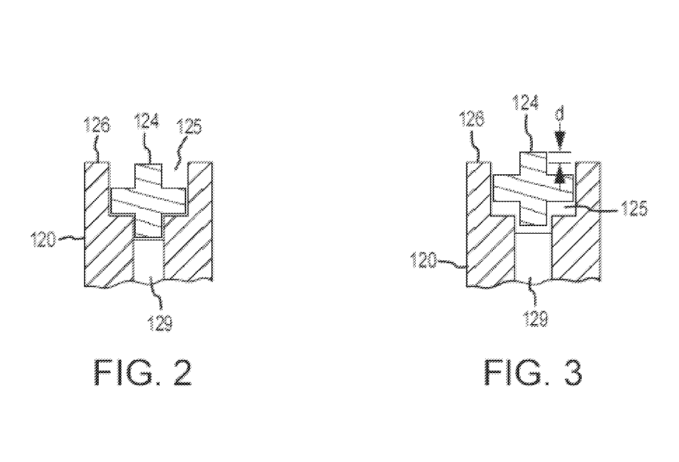

FIG. 2 shows the locking seal 124 of the locking pneumatic piston 100 in a substantially non-actuated position according to an embodiment of the invention. In this figure, the locking seal 124 resides substantially in the seal groove 125. An outer portion of the locking seal 124 may be substantially even with or may be slightly protruding beyond the circumferential surface 126 of the piston 120. As a result, the locking seal 124 can seal the piston 120 to the inner surface 104 of the piston chamber 103. However, in this position, the locking seal 124 will create substantially only a sealing contact and will not generate a locking force against the piston chamber 103.

The locking seal 124 can create a seal against portions of the seal groove 125. For example, the locking seal 124 can substantially seal against the side walls or surfaces of the seal groove 125. In addition, the locking seal 124 can substantially seal against bottom walls or surfaces of the seal groove 125.

The walls or surfaces of the seal groove 125 can be substantially straight and/or planar, as shown. However, it should be understood that the seal groove 125 can be configured in any manner, and other seal groove configurations are contemplated and are within the scope of the description and claims.

FIG. 3 shows the locking seal 124 in a substantially actuated position according to an embodiment of the invention. In this figure, a pneumatic locking pressure has been provided into the pneumatic lock port 117, internal pneumatic channel 127, the one or more passages 129, and into the seal groove 125 below the locking seal 124. As a result, the locking seal 124 has been forced outward, at least somewhat away from the piston 120. This is illustrated by the projection distance (d) in the figure. The projection distance (d) can be varied according to the material of the locking seal 124, the magnitude of the pneumatic locking pressure, the tolerance between the piston 120 and the inner surface 104, and other variables and environmental factors.

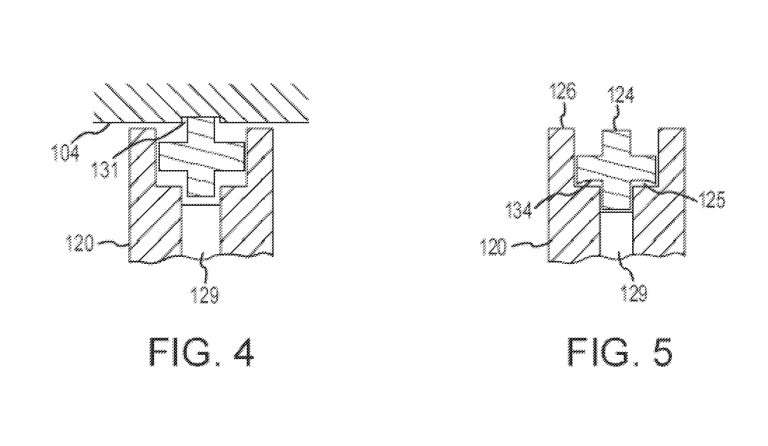

FIG. 4 shows the locking seal 124 in a substantially extended state and engaging one or more detent features 131 formed in the inner surface 104 of the piston chamber 103/piston case 102. The one or more detent features 131 can comprise any manner of grooves, ridges, roughening, etc. The one or more detent features 131 can substantially correspond to the shape of the locking seal 124. Other detent feature shapes are contemplated and are within the scope of the description and claims.

The one or more detent features 131 can be located anywhere on the inner surface 104. The one or more detent features 131 can be located at predetermined detent locations, such as at an expected actuation position, expected actuation end point, etc.

FIG. 5 shows an alternate shape of the locking seal 124 according to an embodiment of the invention. In this embodiment, underside portions 134 of the locking seal 124 are arched or angled so that the pneumatic locking pressure acts on a greater surface area. Consequently, the locking seal 124 of this embodiment may have better initial actuation characteristics. The underside portions 134 can be included in various locking seal embodiments and are not limited to the embodiment shown in the figure.

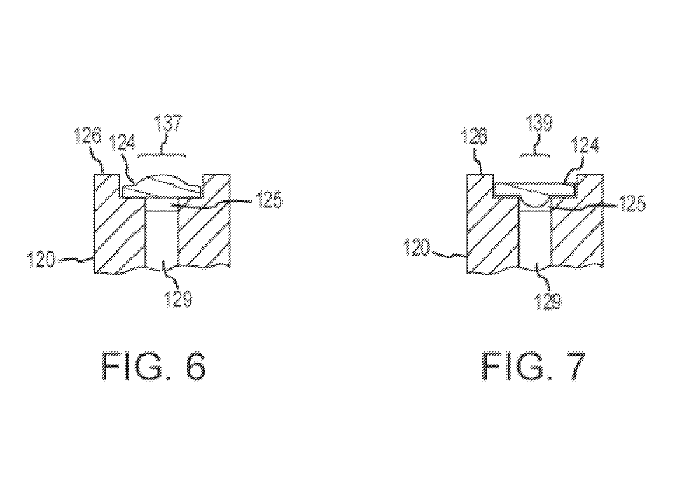

FIG. 6 shows an alternate shape of the locking seal 124 according to an embodiment of the invention. In this embodiment, the locking seal 124 is substantially in the shape of a band or ring. It should be noted that the locking seal 124 can include a thicker center portion 137. The thicker center portion 137 can be included in order to provide an increasing contact with the inner surface 104 of the piston chamber 103 as the pneumatic locking pressure is increased. The thicker center portion 137 can be included in various locking seal embodiments and are not limited to the embodiment shown in the figure.

FIG. 7 shows an alternate shape of the locking seal 124 according to an embodiment of the invention. In this embodiment, the locking seal 124 includes one or more downward projections 139 that correspond to the one or more passages 129. The one or more downward projections 139 can be substantially seated into and substantially aligned by the one or more passages 129. The one or more downward projections 139 can be included in various locking seal embodiments and are not limited to the embodiment shown in the figure.

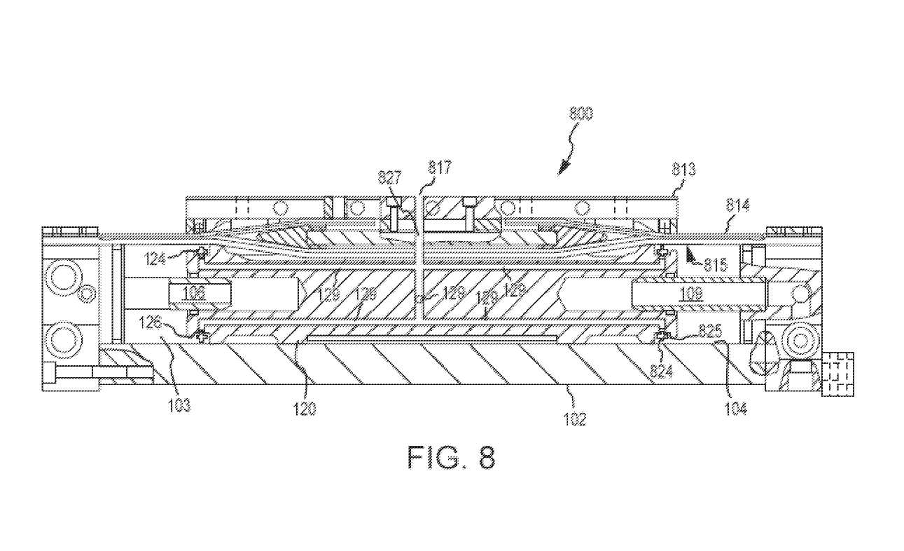

FIG. 8 shows a cross-sectional view of a locking pneumatic piston 800 according to another embodiment. While the above discussion relates to a locking pneumatic piston with the pneumatic locking port 117 formed in a piston rod 113, the embodiment shown in FIG. 8 comprises a rodless pneumatic piston 800. Therefore, the pneumatic locking port 117 cannot be formed in the piston rod 113. Rather, the pneumatic locking port 817 and the internal pneumatic channel 827 are formed in the carriage 813 of the pneumatic piston 800.

As is generally known in the art, rodless pneumatic pistons comprise a movable carriage 813 positioned outside the piston case 102. The carriage 813 is coupled to the piston 120, which is still positioned within the piston case 102. A cover strip 814 and a sealing strip 815 can be used to seal the piston chamber 103 and prevent fluid from escaping while allowing the piston 102 and the carriage 813 to move in the axial direction.

According to an embodiment, the pneumatic locking port 117 and internal pneumatic channel 827 can be formed in a portion of the carriage 813 and extend to the one or more passages 129 formed in the piston 120. As can be appreciated, the pneumatic locking port 817 can be formed in the portion of the carriage 813 that extends around the sealing strip 815, i.e., the portion of the carriage 813 that is coupled to the piston 120.

According to the embodiment shown, the one or more passages 129 provide pneumatic communication to a first locking seal 124 and a second locking seal 824. Therefore, the piston 120 of the embodiment shown includes two locking seals 124, 824 that can work together. It should be appreciated however, that in other embodiments, the single locking seal 124 can be utilized. Therefore, the locking pneumatic piston 800 should not be limited to requiring two locking seals.

As can be appreciated, the remaining components of the locking pneumatic piston 100 described above can be easily incorporated into the locking pneumatic piston 800 and thus, the remaining features are omitted for brevity of the description.

The locking pneumatic piston according to the invention can be employed according to any of the embodiments in order to provide several advantages, if desired. The locking pneumatic piston comprises an economical and mechanically simple locking actuator/piston. The locking pneumatic piston provides an actuator/piston with a quick locking and unlocking capability. The locking pneumatic piston provides an actuator/piston with a repeatable locking capability. The locking pneumatic piston provides an actuator/piston with a locking capability that can lock at a plurality of positions, and not just at beginning and end travel positions. The locking pneumatic piston provides an actuator/piston with no need for a separate locking energy source. The locking pneumatic piston provides an actuator/piston wherein the pneumatic supply can be provided by vehicle.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention should be determined from the following claims.

We claim:

1. A locking pneumatic piston (100), comprising:
a piston rod (113) connected to a piston (120) located in a piston chamber (103), with the piston rod (113) extending out of the piston chamber (103);
a locking seal (124) extending around and positioned at a circumferential surface (126) of the piston (120) and substantially sealing the piston (120) to an inner surface (104) of the piston chamber (103); and
an internal pneumatic channel (127) extending through at least a lengthwise portion of the piston rod (113) and through the piston (120) to the locking seal (124);
wherein when a pneumatic locking pressure is provided to the internal pneumatic channel (127), the pneumatic locking pressure extends the locking seal (124) at least partially outward and away from the piston (120) and presses against the inner surface (104) of the piston chamber (103), substantially locking the piston (120) in place within the piston chamber (103).

2. The locking pneumatic piston (100) of claim 1, with the inner surface (104) of the piston chamber (103) being substantially smooth.

3. The locking pneumatic piston (100) of claim 1, with the inner surface (104) of the piston chamber (103) further comprising one or more detent features (131).

4. The locking pneumatic piston (100) of claim 1, with the locking seal (124) providing a first sealing force against the inner surface (104) in an absence of pneumatic locking pressure and providing a second sealing force when pneumatic locking pressure is provided at the internal pneumatic channel (127), with the second sealing force being greater than the first sealing force.

5. The locking pneumatic piston (100) of claim 1, with the locking seal (124) being at least partially elastomeric.

6. The locking pneumatic piston (100) of claim 1, further comprising:
a seal groove (125) formed in the circumferential surface (126) of the piston (120), with the seal groove (125) being configured to receive at least a portion of the locking seal (124); and
one or more passages (129) extending between the internal pneumatic channel (127) and the seal groove (125).

7. The locking pneumatic piston (100) of claim 1, further comprising a pneumatic lock port (117) formed on the piston rod (113) outside of the piston chamber (103), with the pneumatic lock port (117) being in communication with the internal pneumatic channel (127).

8. A method of providing a locking pneumatic piston, the method comprising:
providing a pneumatic piston including a piston rod; and
providing a pneumatic lock port formed in an exterior portion of the piston rod outside of a piston chamber, wherein a pneumatic lock pressure provided to the pneumatic lock port substantially locks the piston rod in position with respect to the pneumatic piston.

9. The method of claim 8, with providing the pneumatic piston further comprising:
providing the piston rod connected to a piston located in the piston chamber, with the piston rod extending out of the piston chamber;
providing a locking seal extending around and positioned at a circumferential surface of the piston and substantially sealing the piston to an inner surface of the piston chamber; and
providing an internal pneumatic channel extending through at least a lengthwise portion of the piston rod and through the piston to the locking seal;
wherein when a pneumatic locking pressure is provided to the internal pneumatic channel, the pneumatic locking pressure extends the locking seal at least partially outward and away from the piston and presses against the inner surface of the piston chamber, substantially locking the piston in place within the piston chamber.

10. The method of claim 9, with the inner surface of the piston chamber being substantially smooth.

11. The method of claim 9, with the inner surface of the piston chamber further comprising one or more detent features.

12. The method of claim 9, with the locking seal providing a first sealing force against the inner surface in an absence of pneumatic locking pressure and providing a second sealing force when pneumatic locking pressure is provided at the internal pneumatic channel, with the second sealing force being greater than the first sealing force.

13. The method of claim 9, with the locking seal being at least partially elastomeric.

14. The method of claim 9, further comprising:
providing a seal groove formed in the circumferential surface of the piston, with the seal groove being configured to receive at least a portion of the locking seal; and
providing one or more passages extending between the internal pneumatic channel and the seal groove.

15. The method of claim 9, with the pneumatic lock port being in communication with the internal pneumatic channel.

16. A method of providing a locking pneumatic piston, the method comprising:
providing a pneumatic piston including a piston rod;
providing an internal lock mechanism; and
providing a pneumatic lock port formed in an exterior portion of the piston rod outside of a piston chamber and communicating a pneumatic lock pressure in communication with the lock mechanism, wherein the pneumatic lock pressure substantially locks the piston rod in position with respect to the pneumatic piston.

17. The method of claim 16, with providing the pneumatic piston and providing the internal lock mechanism further comprising:
providing the piston rod connected to a piston located in the piston chamber, with the piston rod extending out of the piston chamber;
providing a locking seal extending around and positioned at a circumferential surface of the piston and substantially sealing the piston to an inner surface of the piston chamber; and
providing an internal pneumatic channel extending through at least a lengthwise portion of the piston rod and through the piston to the locking seal;
wherein when a pneumatic locking pressure is provided to the internal pneumatic channel, the pneumatic locking pressure extends the locking seal at least partially outward and away from the piston and presses against the inner surface of the piston chamber, substantially locking the piston in place within the piston chamber.

18. The method of claim 17, with the inner surface of the piston chamber being substantially smooth.

19. The method of claim 17, with the inner surface of the piston chamber further comprising one or more detent features.

20. The method of claim 17, with the locking seal providing a first sealing force against the inner surface in an absence of pneumatic locking pressure and providing a second sealing force when pneumatic locking pressure is provided at the internal pneumatic channel, with the second sealing force being greater than the first sealing force.

21. The method of claim 17, with the locking seal being at least partially elastomeric.

22. The method of claim 17, further comprising:
providing a seal groove formed in the circumferential surface of the piston, with the seal groove being configured to receive at least a portion of the locking seal; and
providing one or more passages extending between the internal pneumatic channel and the seal groove.

23. The method of claim 17, with the pneumatic lock port being in communication with the internal pneumatic channel.

24. A locking pneumatic piston (800), comprising:
a carriage (813) connected to a piston (120) located in a piston chamber (103), with the carriage (813) positioned out of the piston chamber (103);
one or more locking seals (124, 824) extending around and positioned at a circumferential surface (126) of the piston (120) and substantially sealing the piston (120) to an inner surface (104) of the piston chamber (103); and
an internal pneumatic channel (827) extending through at least a portion of the carriage (813) and through the piston (120) to the one or more locking seals (124, 824);
wherein when a pneumatic locking pressure is provided to the internal pneumatic channel (827), the pneumatic locking pressure extends the one or more locking seals (124, 824) at least partially outward and away from the piston (120) and presses against the inner surface (104) of the piston chamber (103), substantially locking the piston (120) in place within the piston chamber (103).

25. The locking pneumatic piston (800) of claim 24, with the inner surface (104) of the piston chamber (103) being substantially smooth.

26. The locking pneumatic piston (800) of claim 24, with the inner surface (104) of the piston chamber (103) further comprising one or more detent features (131).

27. The locking pneumatic piston (800) of claim 24, with the locking seal (124) providing a first sealing force against the inner surface (104) in an absence of pneumatic locking pressure and providing a second sealing force when pneumatic locking pressure is provided at the internal pneumatic channel (827), with the second sealing force being greater than the first sealing force.

28. The locking pneumatic piston (800) of claim 24, with the locking seal (124) being at least partially elastomeric.

29. The locking pneumatic piston (800) of claim 24, further comprising:
one or more seal grooves (125, 825) formed in the circumferential surface (126) of the piston (120), with each of the seal grooves (125, 825) being configured to receive at least a portion of a locking seal of the one or more locking seals (124, 824); and
one or more passages (129) extending between the internal pneumatic channel (827) and the one or more seal grooves (125, 825).

30. The locking pneumatic piston (800) of claim 24, further comprising a pneumatic lock port (817) formed on the carriage (813), with the pneumatic lock port (817) being in communication with the internal pneumatic channel (827).
